(19) United States
(12) Patent Application Publication
(10) Pub. No.: US 2016/0202897 A1
(43) Pub. Date: Jul. 14, 2016

(54) RAPID DISCRETE BROWSING

(71) Applicant: T1VISIONS, INC., Charlotte, NC (US)

(72) Inventors: James E. MORRIS, Lake Wylie, SC (US); Michael R. FELDMAN, Huntersville, NC (US)

(21) Appl. No.: 14/593,870

(22) Filed: Jan. 9, 2015

(51) Int. Cl. G06F 3/0488; G06F 3/0481; G06F 3/0484

(52) U.S. Cl. CPC G06F 3/04883; G06F 3/04842; G06F 3/04817

(57) ABSTRACT

A display system includes a display screen, an interactive sensor, and a computer in communication with the display screen and the interactive sensor, wherein the computer displays an image composed of a two-dimensional matrix of items on the display screen, wherein the computer responds to a non-selection gesture on the matrix discretely for the items.

### BACKGROUND

1. Field

Embodiments are directed to rapid discrete browsing on a touch screen display.

2. Description of the Related Art

Browsing items in a display having a touch screen typically involve pinching an image to view more of an image in lower detail, zooming an image to view less of an image in higher detail, scrolling on an image to shift the image, and so forth. The same action is performed for the entire display.

### SUMMARY

One or more embodiments is directed to a display system including a display screen, an interactive sensor, and a computer in communication with the display screen and the interactive sensor, wherein the computer displays an image composed of a two-dimensional matrix of items on the display screen, wherein the computer responds to a non-selection gesture on the matrix discretely for the items.

When the non-selection gesture is in a first direction along a first axis on a first item, multiple items adjacent the first item along the first axis move in the first direction, and items spaced from the first item along a second axis, orthogonal to the first axis, do not move in the first direction.

Items spaced from the first item along the second axis may not move.

When the non-selection gesture is in a second direction along a second axis on the first item, items adjacent along the first direction may move together in the second direction.

Items adjacent along the first direction may move together in their entirety in the second direction.

The items may be pictures.

### BRIEF DESCRIPTION OF THE DRAWINGS

FIG. 1 illustrates a schematic side view of a display system according to an embodiment; and

FIGS. 2 to 10 illustrate a top schematic view of a display system operating rapid discrete browsing in accordance with an embodiment.

### DETAILED DESCRIPTION

Embodiments are directed to a method of browsing items on a display having a touch screen therein. In particular, embodiments are directed to treating an image as a matrix of separate items and controlling how the image changes in response to input at particular locations on the separate items, rather than treating the entire image in the same manner.

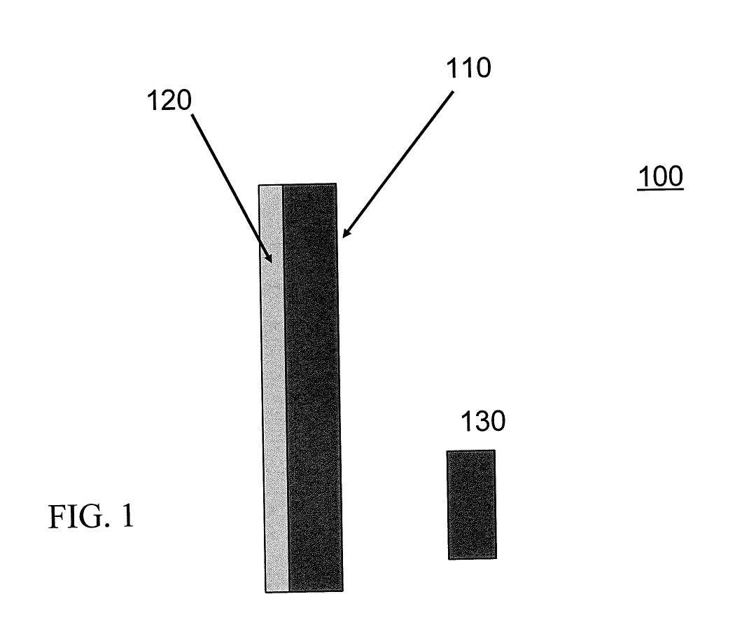

FIG. 1 illustrates a schematic side view of a display system according to an embodiment, in which a display system 100 includes a display screen 110, a interactive sensor 120, and a computer 130 in communication with the display screen and the interactive sensor 120. Such interactive sensors may include touch sensors, gesture sensors, and so forth.

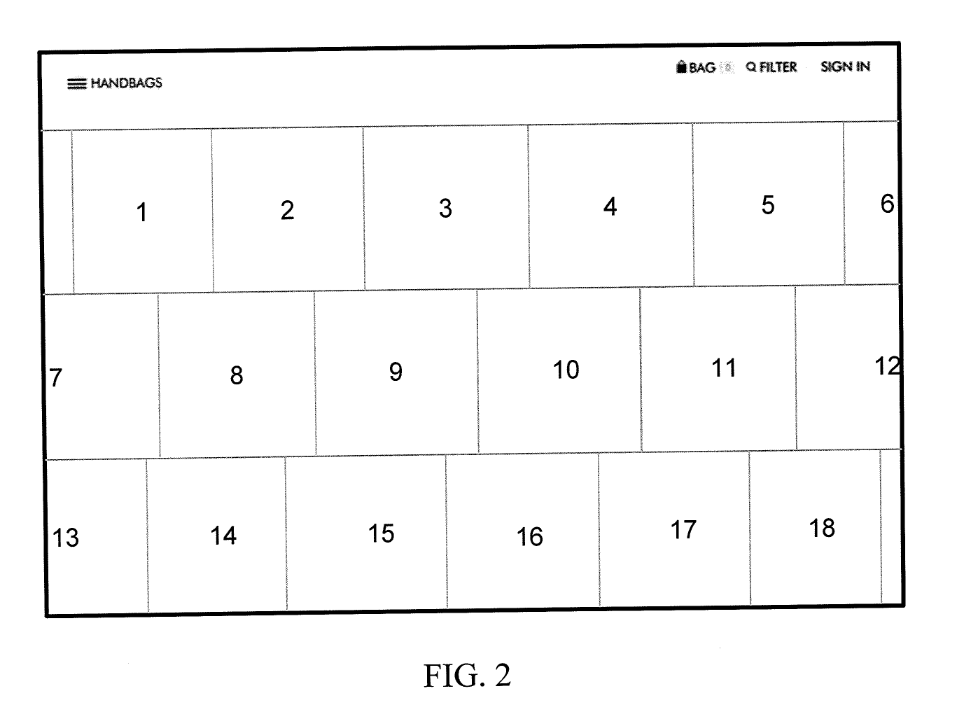

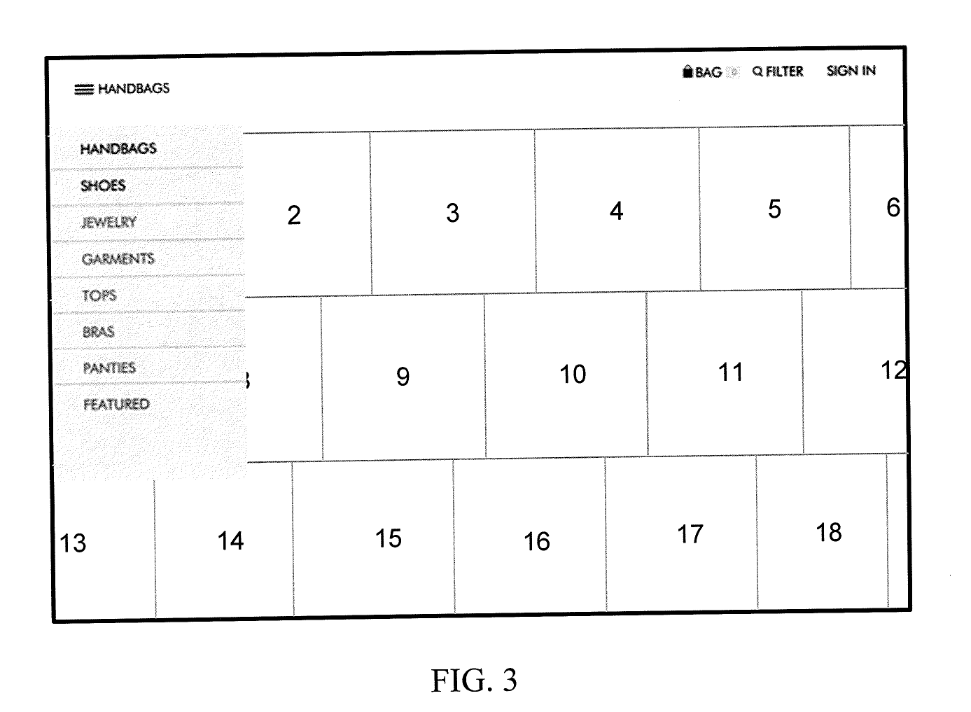

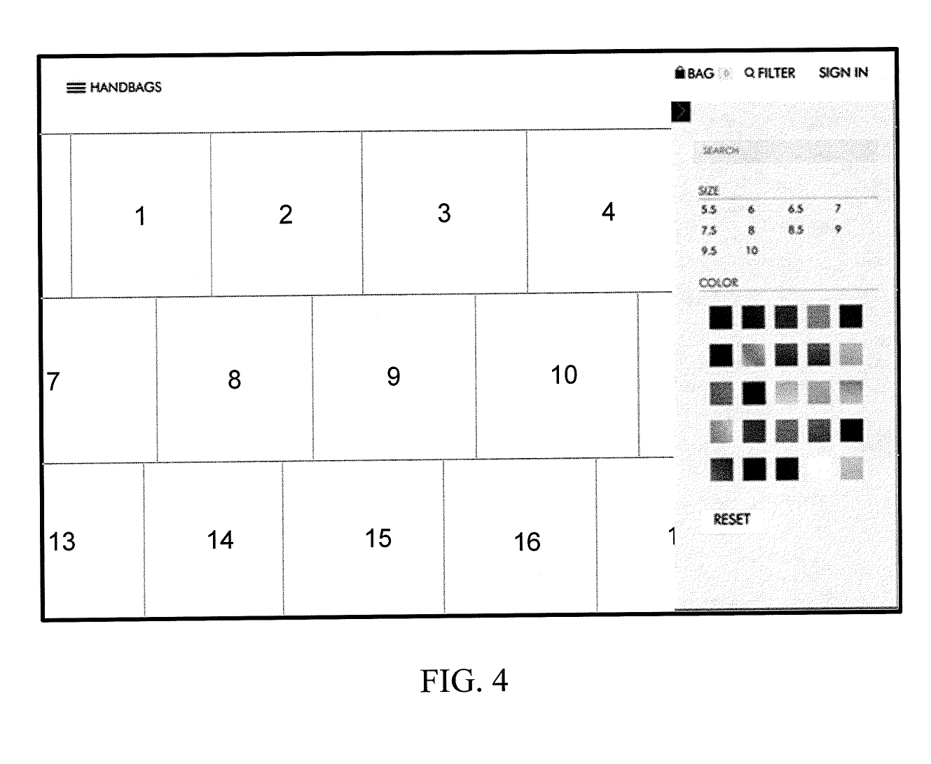

FIG. 2 illustrates a top schematic view of the display system 100 displaying a matrix of items, e.g., pictures, videos, images, and so forth, to be browsed, here three rows of individually numbered items. In FIGS. 3 and 4, conventional filtering by item type may also be employed.

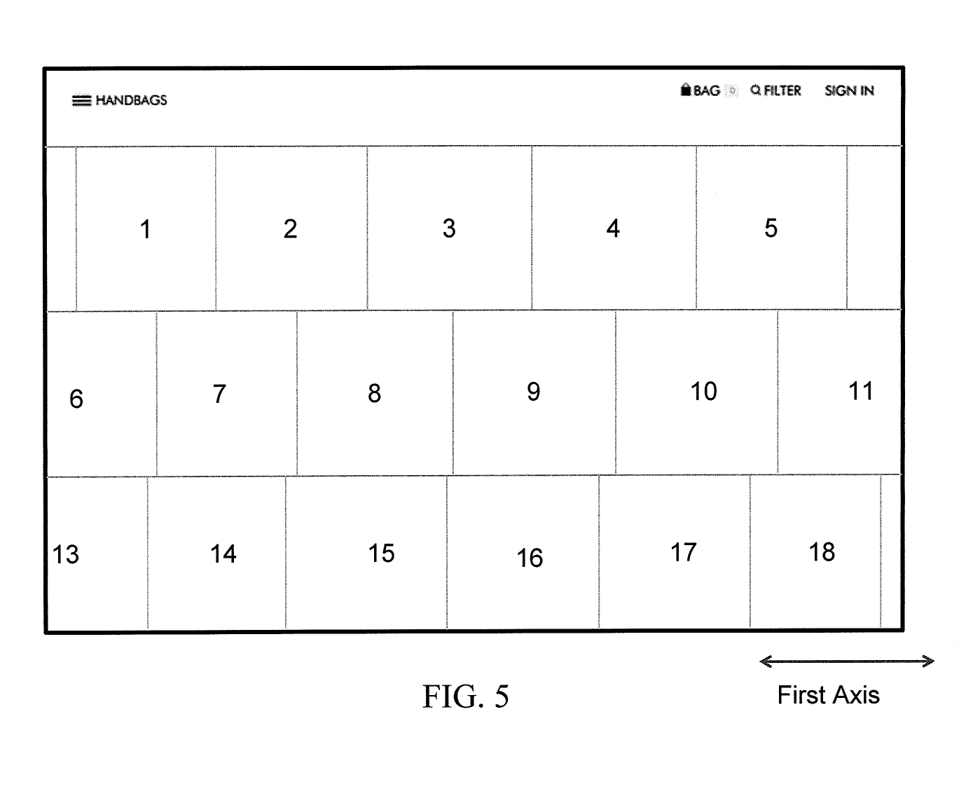

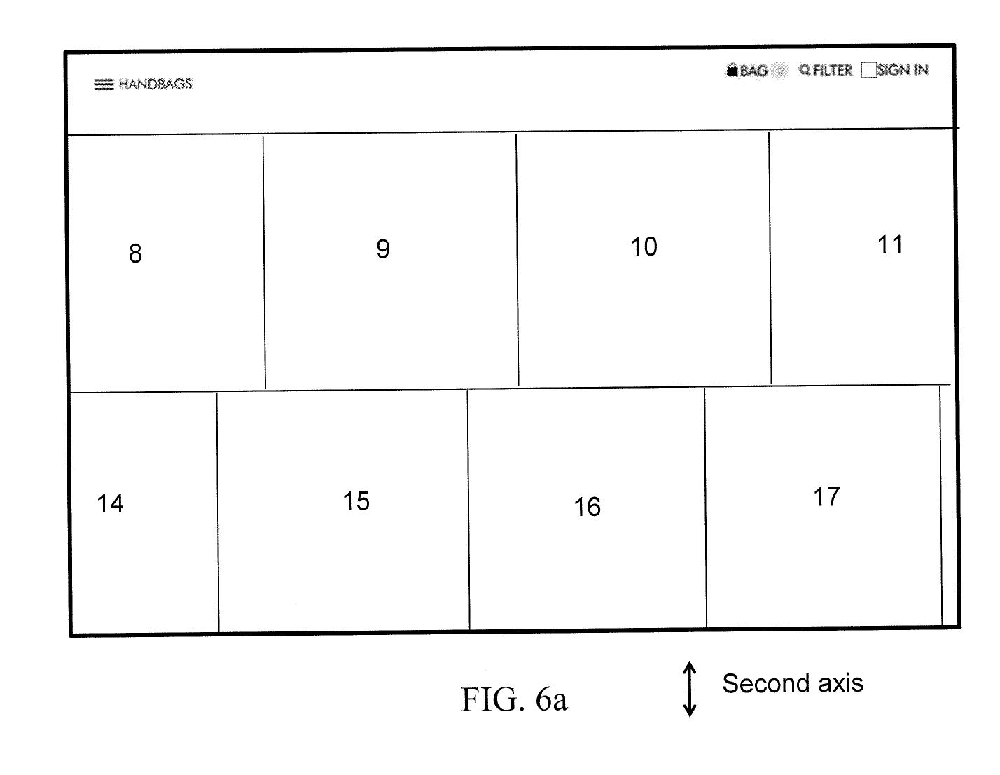

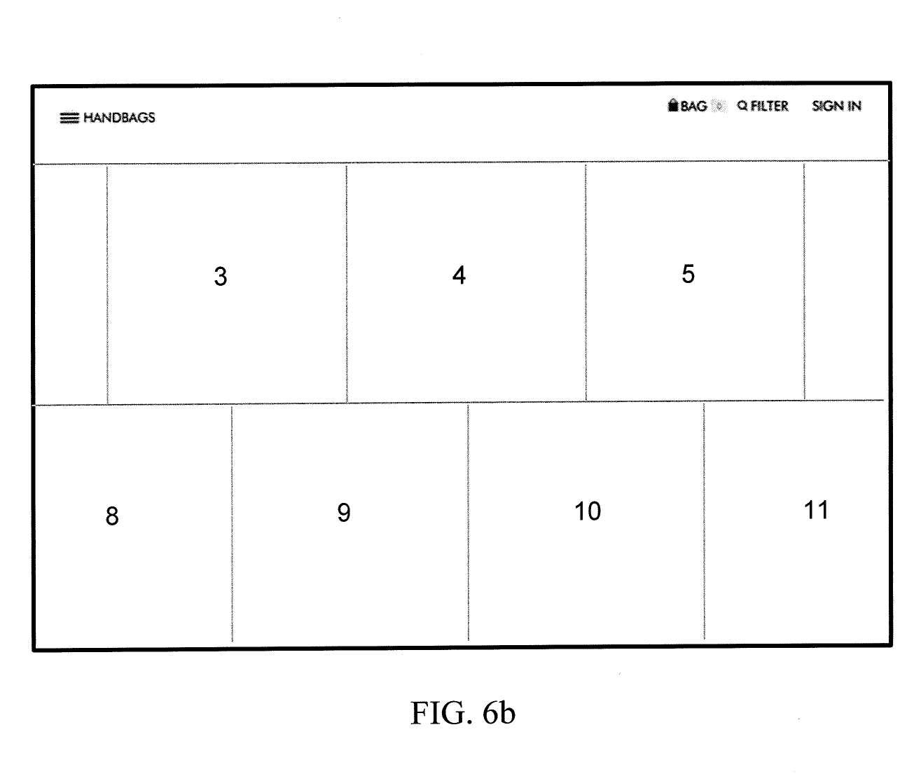

In FIG. 5, the center row has been scrolled in a first direction along a first axis, here to the right, relative to FIG. 2, while the upper and lower rows are treated differently. In the example shown in FIG. 5, the upper and lower rows are unchanged, such different treatment may also include remaining stationary, moving in an opposite direction, i.e., a second direction to the left along the first axis, the upper and lower rows could fade, the upper and lower rows could shrink while increasing the center row. In contrast, conventional scrolling would have scrolled all rows on the screen in the first direction along the first axis. If the center row had been scrolled up or down, the matrix would shift the image be an entire row, not just incrementally (see FIGS. 6a and 6b) or nothing may happen to the items.

In FIG. 6a, when the item 15 in the bottom row is zoomed, the top row may be removed from view, but the remaining rows may fill the screen. In contrast, conventional zooming would have zoomed the entire image, such that only a portion of the upper row would be viewed. If the bottom row had been pinched, an additional row, e.g., another upper or lower row, would be displayed. In contrast, conventional pinching would have reduced the entire image, such that only a portion of any additional row would be viewed.

In FIG. 6b, the top row has been scrolled in a first direction along a second axis, here down, such that the bottom row of FIG. 6a is no longer being viewed, the top row of FIG. 6a is now the bottom row of FIG. 6b, and a new row is the top row in FIG. 6b.

In other words, when the items are arranged in a two-dimensional matrix, i.e., items arranged along a first axis and along a second axis, orthogonal to the first axis, one axis may be selected as the primary axis of the rapid browser. In the embodiments shown herein, the primary axis is the first axis or row direction. Movement of items along the first axis results in other items arranged in the same row to move is a same direction, while items in other rows to be treated differently. Movement of items in a direction along the second axis will result in all rows being moved on a discrete basis (row by row) in the direction. In contrast, if the second or column axis is the primary axis, items in the same column would be moved together along the second axis and movement of items in a direction along the first axis will result in all columns being moved on a discrete basis (column by column in the direction).

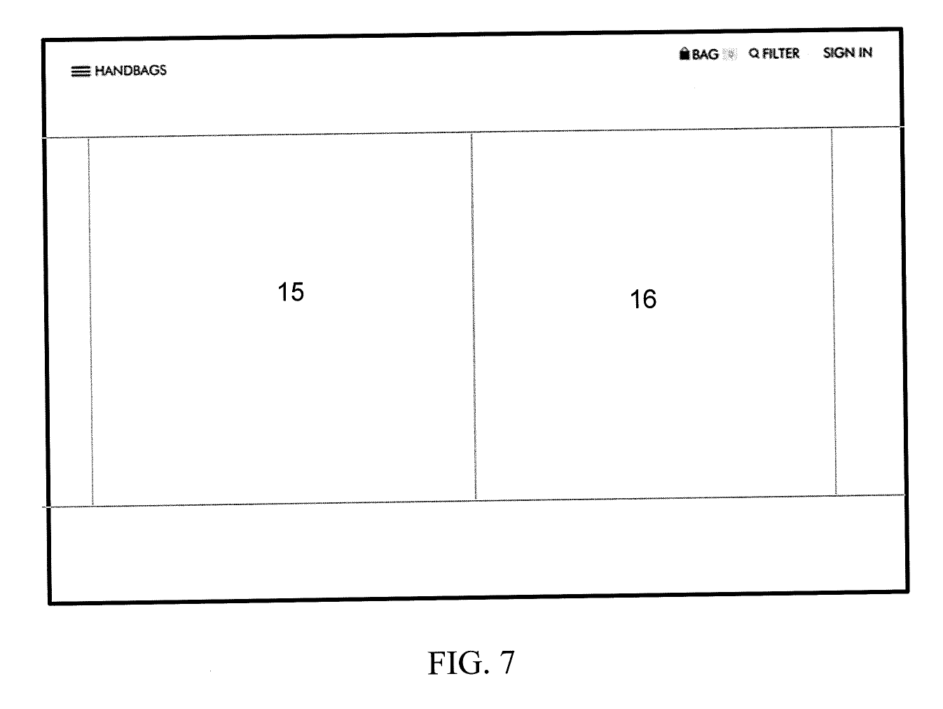

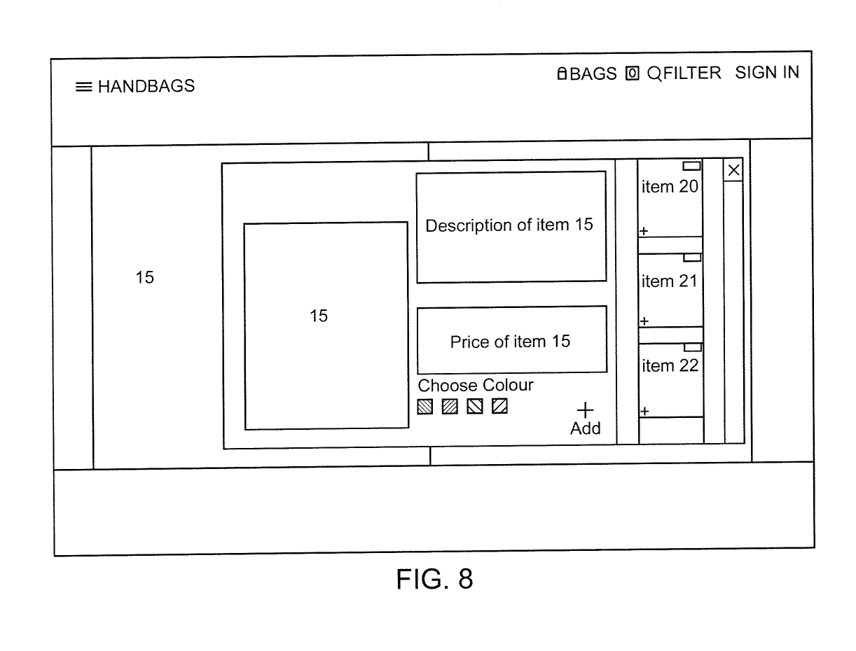

In FIG. 7, when item 15 of FIG. 6a is zoomed again, two items, e.g., items 15 and 16, now fill the screen, without extraneous partial items. In FIG. 8, when item 15 is selected, e.g., tapped on, all of the information regarding item 15 is displayed.

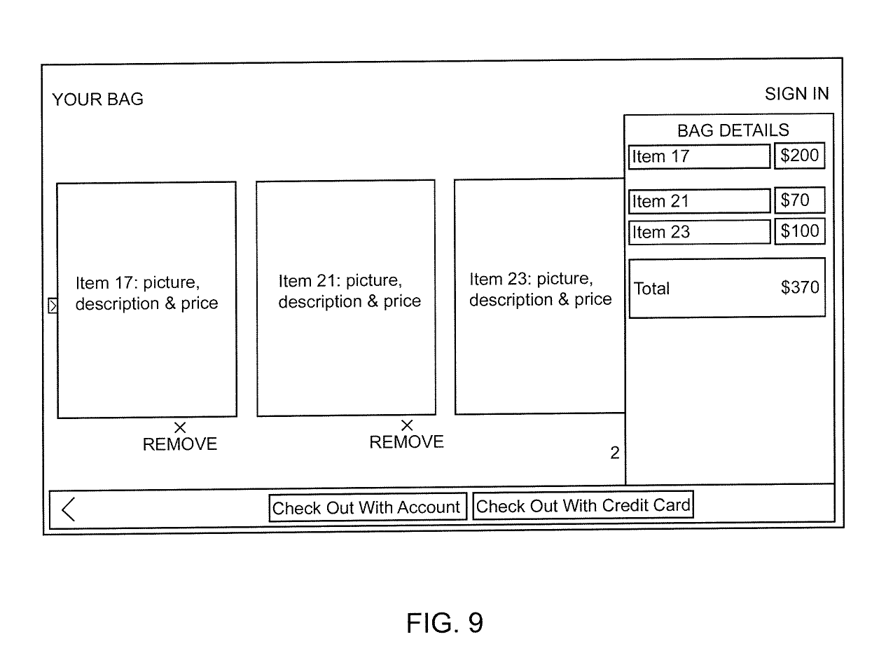

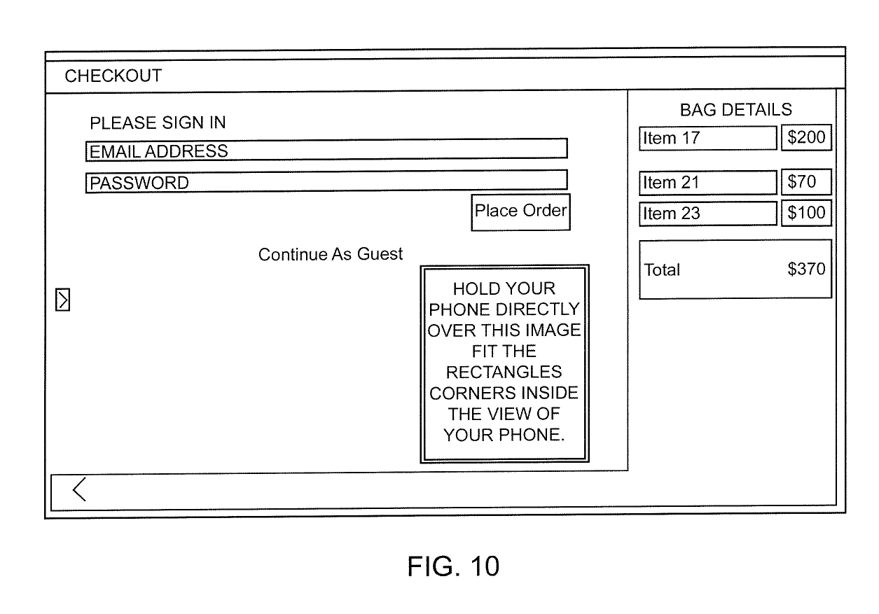

In FIG. 9, when ready to checkout, a user may select checkout with account, which would result in the display FIG. 10. Then, a user may follow the instructions regarding using a mobile phone, as disclosed in co-pending application PCT/US2015/010838, entitled “Display Capable of Object Recognition,” filed Jan. 9, 2015, which is incorporated herein by reference.

By way of summation and review, embodiments are directed to treating an image as being composed of items arranged in a matrix, e.g., a matrix of at least two dimensions, and discretely controlling items row by row (or column by column) for non-selection gestures, e.g., pinch, scroll, zoom. Thus, items displayed on a screen may be readily browsed.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A display system, comprising:
a display screen;
an interactive sensor; and
a computer in communication with the display screen and the interactive sensor, wherein the computer displays an image composed of a two-dimensional matrix of items on the display screen, wherein the computer responds to a non-selection gesture on the matrix discretely for the items.

2. The display system of claim 1, wherein, when the non-selection gesture is in a first direction along a first axis on a first item, multiple items adjacent the first item along the first axis move in the first direction, and items spaced from the first item along a second axis, orthogonal to the first axis, do not move in the first direction.

3. The display system of claim 2, wherein items spaced from the first item along the second axis do not move.

4. The display system of claim 2, wherein, when the non-selection gesture is in a second direction along a second axis on the first item, items adjacent along the first direction move together in the second direction.

5. The display system of claim 4, wherein items adjacent along the first direction move together in their entirety in the second direction.

6. The display system of claim 1, wherein the items are pictures.
